(19) United States
(12) Patent Application Publication
(10) Pub. No.: US 2008/0103809 A1
(43) Pub. Date: May 1, 2008

(54) Method for preventing and/or deterring a criminal act

(76) Inventor: Philip A. Cleary, Newport (GB)

Correspondence Address: DENNISON, SCHULTZ & MACDONALD, 1727 KING STREET, SUITE 105, ALEXANDRIA, VA, 22314, US

(21) Appl. No.: 11/976,627

(22) Filed: Oct. 26, 2007

Related U.S. Application Data
(60) Provisional application No. 60/854,713, filed on Oct. 27, 2006.

(51) Int. Cl. G06Q 10/00; G06Q 90/00

(52) U.S. Cl. 705/1

(57) ABSTRACT

A method of preventing and/or deterring a criminal act, comprising standardizing a coordinated approach to a coding system for the identification of stolen property; advertising or publishing the method through a coordinated media campaign to maximize the psychological impact on the criminal mind that acts as the deterrent; and (3) sustaining the deterrent effect by equipping and training police forces so as to maximize the effectiveness of identifying and gathering evidence.

This application claims the benefit of U.S. Provisional Application No. 60/854,713, filed Oct. 27, 2006.

The present invention is based upon the use of effective technology in the field of forensic analysis. It is based upon the production of unique mixtures that can be applied to items or individuals, sampled and analyzed to provide information that can be used in various ways within a criminal justice system. Coupled with this are overt installation of detector equipment in police stations and police vehicles, locally, regionally and nationally, followed by effective use of media to publicize this fact and the successes that the technology has achieved. The method will create anxiety within the criminal fraternity and produce a significant and sustainable deterrent to crime.

Various methods and systems for labeling and/or identifying stolen property appear in the art, including U.S. Pat. No. 4,226,194; U.S. Pat. No. 4,858,465; U.S. Pat. No. 5,360,628, and U.S. Pat. No. 5,599,578.

The inventive method comprises (1) standardizing a coordinated approach to a coding system for the identification of stolen property, (2) advertising or publishing the method through a coordinated media campaign to maximize the psychological impact on the criminal mind that acts as the deterrent, and (3) sustaining the deterrent effect by equipping and training police forces so as to maximize the effectiveness of identifying and gathering evidence.

These three aspects of the invention will now be described in more detail.

### Standardization:

Standardization is the first platform of the method, and is fundamental to achieving a coordinated approach to the use of forensic coding systems, of both property and suspects, and realizing the benefits which follow:
The method preferably requires a single operating system for the identification of suspected stolen property, including the selection of one forensic coding system which can be used for all types of property. This will result in improvements in the identification of suspected stolen property.
It gives police forces the opportunity to create a real and meaningful deterrent, thereby increasing community assurance in relation to burglary by heightening anxiety within the criminal fraternity.

### Advertising:

Another cornerstone of the method is the development of a coordinated media strategy to maximize the psychological impact on the criminal mind that acts as the deterrent. Success of the system and its ability to ensure continuing media interest will attract regular attention of the news media. The power of the media is not to be underestimated in terms of getting the message over to the criminal and the wider public.

Opportunities include:
TV/radio—news bulletins focusing on launch, arrests and convictions, also interviews and dramatic demonstrations.
Press—regional coverage highlighting adoption of the method.
Posters—in police stations, schools, libraries and other public buildings, highlighting the positive benefits.
Warning Notices—in custody suites advising suspects that they will be screened for the presence of the marker.
Street signs—advertising the use of the method in a particular locality.
Warning labels—displayed in homes, vehicles and commercial premises protected by the method.
Frequent revisiting of media strategy, looking for opportunities to enhance criminals' fear.

A carefully executed and sustained media campaign enables police forces to simultaneously educate the criminal and reduce community anxiety.

### Sustaining:

The presence of an effective deterrent is another key element of the inventive method. It involves the deployment of covert deployment spray units in known “hot spots” and the use of the media to highlight any arrests or convictions resulting therefrom.

In detail, the following steps are necessary to sustain the method:

(1) The use of an automated system triggered by offenders, or those under duress during the course of an offence, deploying a traceable liquid that will provide proof of ownership and prima facie evidence of the presence of individuals at the venue and at the time of the offence.

(2) The trace may be based on several systems such as chemical additives, natural, synthetic or semi-synthetic DNA, etc. However, these must be of sufficient rigor to withstand forensic scrutiny and ideally, have successful prior use within an established criminal justice system. Preferred products are those, such as SmartWater, made by SmartWater Technology Ltd, a UK based company.

(3) The use of SmartWater deployment systems in covert operations by local law enforcement agencies is also vital to the system. Based on information received and local knowledge, devices can be installed in “high risk” locations. In the majority of cases suspects are known and can be located in their residence after the event, which saves police time and expense in surveillance operations.

(4) The psychological impact can be maximized in police stations where those of a criminal inclination could spend time and will also report back to colleagues similarly disposed, thus building the credence of the deterrent. Installation of UV detection equipment in custody suites and the displaying of associated warning notices by the police force in the area in which the deployment device is situated are all important. Ideally this approach should be accompanied by the development of a local force policy to screen all suspects entering custody suites.

(5) Local police forces should be encouraged in:
The installation of UV lighting and the screening (to detect the presence of SmartWater) of all stolen, suspect and found property entering police stations.
The use of UV lights by officers executing search warrants and searching suspects' houses. Not only does this approach assist in the recovery of stolen property, it also sends a very clear message to those witnessing the process.
Routine police visits to yard sales and second-hand dealers' premises, and the use of portable UV lighting by officers to screen all property being offered for sale.

(6) Equipping police officers with UV key fobs (or similar) and providing easy access to powerful UV lamps.

(7) Formalized familiarisation/training programs (as appropriate) for police officers and police staff.

(8) Encouraging and facilitating the adoption of SmartWater by education departments and schools to reinforce the concept of right and wrong being developed within the school.

(9) Renewal of SmartWater schemes and refreshment of the SmartWater deterrent through re-coding of newly purchased items. This is an important element of the strategy since property churn (replacement) will gradually erode the number of items which are coded. As this becomes known within the criminal fraternity, the deterrent effect will decrease.

(10) The method requires that police scenes of crime officers with responsibility for the area in question must be trained to identify and successfully sample those surfaces to which the mark has been applied and the sampling of which is considered important to the successful prosecution of the inquiry.

(11) The method requires that the trace sampled should provide evidence at two levels. The first is purely indicative, but none the less vital, in that it should prove the presence of the item at the time of a deployment. It should also identify without ambiguity, the trace system in use. Without this successful operation of the second level, providing the prima facie evidence is not possible since the required analytical methods and protocols cannot be established. Several such first level systems can be used but fluorescence is a simple and preferred first level device. As above, police would “visit” suspects and test for this first level indication. If found, this would then trigger second level investigation.

(12) The second level provides prima facie evidence in a court of law. Providing this level of proof puts an absolute requirement upon the ability of the system used to produce unique mixtures on a global basis. Crucial to this is the requirement for one central control generating and issuing the trace solutions. Clearly without this, identical mixtures may be produced accidentally by commercially unrelated organizations, even competitors, based on the same trace system as could be the case with companies now offering synthetic DNA.

(13) Of fundamental importance to the whole system is the analytical methodology used to identify the unique codes present in the sampled layer.

(14) Vital to the method is the ability of the organization to offer local law enforcement agencies a free analytical service based on this methodology. This should be of the highest quality, operating to forensic standards, to provide a mechanism whereby evidence gathered from the scene by trained scene of crimes officers, can be analyzed quickly and professionally whilst maintaining the evidence chain. Those performing the analysis should have “expert witness” status, enjoy the confidence of the forensic authorities and be able to present evidence in a manner which if required could be used to convict, or indeed, prove innocence in a court of law.

It will be observed that the present invention has apparent utility in a wide variety of fields beyond those described herein. The disclosure herein illustrates the presently-known preferred embodiments for utilizing the method of the present invention. Therefore, the foregoing is considered as illustrative only of the principles of the invention. Further, since numerous modification and changes will readily occur to those skilled in the art, it is not desired to limit the invention to the exact construction and operation described, and accordingly, all suitable modification and equivalents may be resorted to, falling within the scope of the invention. All citations referred to herein are incorporated expressly herein by reference.

1. A method of preventing and/or deterring a criminal act, the method comprising
(1) standardizing a coordinated approach to a coding system for the identification of stolen property;
(2) advertising or publishing the method through a coordinated media campaign to maximize the psychological impact on the criminal mind that acts as the deterrent; and
(3) sustaining the deterrent effect by equipping and training police forces so as to maximize the effectiveness of identifying and gathering evidence.

2. The method of claim 1 wherein the coding system comprises a chemical or biochemical molecule or compound.
